(19) United States
(12) Patent Application Publication
(10) Pub. No.: US 2020/0236237 A1
(43) Pub. Date: Jul. 23, 2020

(54) IMAGE FORMING APPARATUS, METHOD OF CONTROLLING SHEET INSERTION AND NON-TRANSITORY COMPUTER-READABLE RECORDING MEDIUM

(71) Applicant: KONICA MINOLTA, INC., Tokyo (JP)

(72) Inventor: Yusuke YAMAMOTO, Tokyo (JP)

(73) Assignee: KONICA MINOLTA, INC., Tokyo (JP)

(21) Appl. No.: 16/738,823

(22) Filed: Jan. 9, 2020

(30) Foreign Application Priority Data
Jan. 17, 2019 (JP) 2019-005611

(51) Int. Cl. H04N 1/00; B65H 29/62; B65H 43/04; G06F 3/12

(52) U.S. Cl. CPC H04N 1/00641; B65H 29/62; B65H 43/04; G06F 3/1208; H04N 1/00596; H04N 1/00034; G06F 3/1255; H04N 1/00005

(57) ABSTRACT

Provided are an image forming apparatus, a method of controlling sheet insertion and a non-transitory computer-readable recording medium. The image forming apparatus includes a print engine, an image checker, a sheet inserter, a sheet ejector and one or more controllers. When the image checker receives a media sheet output from the print engine, the one or more controllers perform a check whether an image formed on the media sheet is defective or not, by using measured image obtained by a sensor of the image checker. The one or more controllers further cause a sheet inserter to start putting an insertion sheet into the sheet path, after a determination that an image of one of media sheets output from the print engine is non-defective is made, as a result of the check.

Japanese Patent Application No. 2019-005611 filed on Jan. 17, 2019, including description, claims, drawings, and abstract, the entire disclosure of which is incorporated herein by reference in its entirety.

### TECHNOLOGICAL FIELD

The present invention is directed to image forming apparatuses, methods for controlling sheet insertion, and non-transitory computer-readable recording media each storing a program for controlling sheet insertion. In particular, the present invention is directed to image forming apparatuses equipped with a sheet inserter for inserting insertion sheets between media sheets, methods for controlling sheet insertion in the image forming apparatus, and non-transitory computer-readable recording media each storing a program for controlling sheet insertion to be executed in the image forming apparatus.

### BACKGROUND

Image forming apparatuses like MFPs (multi-functional peripherals) provide various kinds of capability. For example, on the market, there are image forming apparatuses capable of checking an image formed on each printed media sheet and of inserting insertion sheets between printed media sheets by using a sheet inserter.

As an example of techniques relating to such image forming apparatuses equipped with a sheet inserter, Japanese Unexamined Patent Publication (JP-A) No. 2008-094570 discloses the following image forming system. The image forming system includes an image forming apparatus, an insertion-sheet feeder, a post-processor, a sensor and a mode selector. The image forming apparatus is configured to form images on media sheets. The insertion-sheet feeder is configured to feed insertion sheets into a sheet path downstream of the image forming apparatus. The post-processor is configured to receive the media sheets processed by the image forming apparatus and insertion sheets fed by the insertion-sheet feeder, and finish the received sheets. The sensor is configured to detect the presence of an abnormality in conveyance of each insertion sheet that is being fed from the insertion-sheet feeder to the post-processor. The mode selector is configured to change a sheet-conveyance mode to one of: a productive mode in which, without waiting for a completion of the detection of the presence of an abnormality in conveyance of an insertion sheet with the sensor, the image forming system starts conveyance of the next media sheet fed from the image forming apparatus, succeeding to the insertion sheet; and a quality-first mode in which, after the completion of the detection of the presence of an abnormality in conveyance of an insertion sheet with the sensor, the image forming system starts conveyance of the next media sheet.

When a problem or defect has been detected in a printed image on a media sheet downstream of an insertion sheet after the insertion sheet had been put into the sheet path, the insertion sheet in the sheet path needs to be ejected to be disposed together with the printed media sheet with a defective image, as spoilage, even if the insertion sheet is usable, because the feeding of the upstream insertion sheet is earlier than the detection of a defective image on the downstream media sheet. It causes not only a problem that a usable insertion sheet or sheets are spoiled and a number of sheets are wastefully used in a process to make print products in total, but also a problem that, in a case that ordered insertion sheets (insertion sheets to be put between printed media sheets in predetermined order, like insertion sheets with page numbers) are used in this process, the pages of a resulting print product becomes out of order.

### SUMMARY

The present invention is directed to image forming apparatuses, methods of controlling sheet insertion, and non-transitory computer-readable recording media each storing a program for controlling sheet insertion, which can reduce wasteful use of insertion sheets and maintain the correct page order of print products, in operations of the image forming apparats to create one or more print products according to a job, with putting insertion sheets between printed media sheets.

The present invention is further directed to image forming apparatuses, methods of controlling sheet insertion, and non-transitory computer-readable recording media each storing a program for controlling sheet insertion, which can minimize a fall of the productivity of the image forming apparatus even if spoilage of sheets occurs in the operations of the image forming apparatus.

An image forming apparatus reflecting one aspect of the present invention is an image forming apparatus that processes a job to create one or more print products. The image forming apparatus comprises a print engine that forms images on respective media sheets; an image checker; a sheet inserter; a sheet ejector; and one or more controllers. The image checker comprises a sensor that, in response to the image checker receiving a media sheet output from the print engine, reads an image formed on the media sheet to obtain a measured image for use in a check whether the image is defective or not. The sheet inserter puts insertion sheets into a sheet path between the print engine and the image checker. The sheet ejector ejects media sheets subjected to the check and insertion sheets put into the sheet path by the sheet inserter, and comprises a first ejection path for ejecting media sheets with images determined to be non-defective together with insertion sheets put between the media sheets, and a second ejection path, which is different from the first ejection path, for ejecting media sheets with images determined to be defective. On the image checker receiving a media sheet output from the print engine, the one or more controllers perform, by using the measured image obtained by the sensor, a check whether an image formed on the media sheet is defective or not. The one or more controllers further cause the sheet inserter to start putting an insertion sheet into the sheet path, after a determination that an image of one of media sheets output from the print engine is non-defective is made, as a result of the check.

A method reflecting one aspect of the present invention is a method of controlling sheet insertion in an image forming apparatus that processes a job to create one or more print products. The image forming apparatus comprises: a print engine that forms images on respective media sheets; an image checker; sheet inserter; sheet ejector; and one or more controllers. The image checker comprises a sensor that, in response to the image checker receiving a media sheet output from the print engine, reads an image formed on the media sheet to obtain a measured image for use in a check whether the image is defective or not. The sheet inserter puts insertion sheets into a sheet path between the print engine and the image checker. The sheet ejector ejects media sheets subjected to the check and insertion sheets put into the sheet path by the sheet inserter, and comprises a first ejection path for ejecting media sheets with images determined to be non-defective together with insertion sheets put between the media sheets, and a second ejection path, which is different from the first ejection path, for ejecting media sheets with images determined to be defective. The method comprises: on the image checker receiving a media sheet output from the print engine, performing, by the one or more controllers, a check whether an image formed on the media sheet is defective or not, by using the measured image obtained by the sensor; and causing the sheet inserter to start putting an insertion sheet into the sheet path, by the one or more controllers, after a determination that an image of one of media sheets output from the print engine is non-defective is made, as a result of the check.

A non-transitory computer-readable recording medium reflecting one aspect of the present invention stores a program for controlling sheet insertion in an image forming apparatus that processes a job to create one or more print products. The image forming apparatus comprises: a print engine that forms images on respective media sheets; an image checker; a sheet inserter; a sheet ejector; and one or more controllers. The image checker comprises a sensor that, in response to the image checker receiving a media sheet output from the print engine, reads an image formed on the media sheet to obtain a measured image for use in a check whether the image is defective or not. The sheet inserter puts insertion sheets into a sheet path between the print engine and the image checker. The sheet ejector ejects media sheets subjected to the check and insertion sheets put into the sheet path by the sheet inserter, and comprises a first ejection path for ejecting media sheets with images determined to be non-defective together with insertion sheets put between the media sheets, and a second ejection path, which is different from the first ejection path, for ejecting media sheets with images determined to be defective. The program comprises instructions which, when being executed by the one or more controllers, cause the one or more controllers to perform the following operations. The operations comprise: on the image checker receiving a media sheet output from the print engine, performing, by using the measured image obtained by the sensor, a check whether an image formed on the media sheet is defective or not; and causing the sheet inserter to start putting an insertion sheet into the sheet path, after a determination that an image of one of media sheets output from the print engine is non-defective is made, as a result of the check.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a schematic diagram illustrating an example of the constitution of an image forming apparatus according to an embodiment of the present invention;

FIGS. 2A and 2B are block diagrams illustrating an example of the constitution of the image forming apparatus;

FIG. 3 is a schematic diagram illustrating an example of timing of feeding an insertion sheet in the image forming apparatus;

FIG. 4 is a schematic diagram illustrating another example of timing of feeding an insertion sheet (in a case that a pair of insertion sheets in the sheet path are estimated to be ordered insertion sheets) in the image forming apparatus;

FIG. 5 is a schematic diagram illustrating another example of timing of feeding an insertion sheet (in a case that a pair of insertion sheets in the sheet path are estimated to be unordered insertion sheets) in the image forming apparatus;

FIG. 6 is a schematic diagram illustrating an example of an insertion-sheet check (in which a comparison of insertion sheets is made each time when the image checker receives an insertion sheet) according to an embodiment of the present invention;

FIG. 7 is a schematic diagram illustrating another example of an insertion-sheet check (in which an comparison of insertion sheets is made on the basis of measured images of faces at the same side of the insertion sheets) according to an embodiment of the present invention;

FIG. 8 is a schematic diagram illustrating another example of an insertion-sheet check (in which, after the estimation of the kind of insertion sheets came to the same result for two pairs of insertion sheets in succession, the estimation for the remaining insertion sheets is omitted) according to an embodiment of the present invention;

FIG. 9 is a schematic diagram illustrating another example of an insertion-sheet check (in which, after the estimation of the kind of insertion sheets came to the same result for pairs of insertion sheets in one print product, the estimation for insertion sheets of the following print products is omitted) according to an embodiment of the present invention;

FIGS. 10A and 10B are schematic diagrams illustrating another example of an insertion-sheet check (in which different results are made according to the number of estimations that had been performed) according to an embodiment of the present invention;

FIG. 11 is a schematic diagram illustrating another example of an insertion-sheet check (in which the estimation is performed on the basis of predetermined areas of insertion sheets) according to an embodiment of the present invention;

FIG. 12 is a schematic diagram illustrating another example of an insertion-sheet check (in which the estimation is performed on the basis of surface profiles of insertion sheets) according to an embodiment of the present invention;

FIG. 13 is a schematic diagram illustrating another example of an insertion-sheet check (in which the estimation is performed on the basis of colors of insertion sheets) according to an embodiment of the present invention;

FIG. 14 is a diagram illustrating an example of operation modes of the image forming apparatus;

FIG. 15 is a schematic diagram illustrating an example of sheet ejection (ejecting a media sheet with a printed image determined to be non-defective) in the image forming apparatus;

FIG. 16 is a schematic diagram illustrating another example of sheet ejection (ejecting a media sheet with a printed image determined to be defective) in the image forming apparatus; and

FIG. 17 is a flowchart illustrating an example of operations of the image forming apparatus.

### DETAILED DESCRIPTION OF EMBODIMENTS

Hereinafter, one or more embodiments of the present invention will be described with reference to the drawings. However, the scope of the invention is not limited to the illustrated embodiments.

As indicated in BACKGROUND, in operations to put an insertion sheet in a sheet path in an image forming apparatus capable of checking an image formed on each media sheet and inserting insertion sheets between printed media sheets by using a sheet inserter, the following problem can arise. When a problem or defect has been detected in a printed image on a media sheet downstream of an insertion sheet after the insertion sheet had been put into the sheet path, the insertion sheet in the sheet path needs to be ejected to be disposed together with the printed media sheet with a defective image, as spoilage, even if the insertion sheet is usable. It causes not only a problem that a usable insertion sheet or sheets are spoiled and a number of sheets are wastefully used in a process to make print products in total, but also a problem that, in a case that ordered insertion sheets are used for this process, the pages of a resulting print product becomes out of order.

In view of that, the following image forming apparatus that processes a job to create one or more print products is given as one embodiment according to the present invention. The image forming apparatus is configured to suspend feeding of an insertion sheet into a sheet path during a detection of the presence of a defective image formed on one of printed media sheets (a check whether an image formed on the media sheet is defective or not), and cause a sheet inserter to start putting an insertion sheet into the sheet path after a determination that an image of the media sheet is non-defective is made. In concrete terms, the image forming apparatus includes a print engine that forms images on respective media sheets, an image checker, a sheet inserter, a sheet ejector and one or more controllers. The image checker is equipped with a sensor that, in response to the image checker receiving a media sheet output from the print engine, reads an image formed on the media sheet to obtain a measured image for use in a check whether the image is defective or not. The sheet inserter is disposed so as to put insertion sheets into a sheet path between the print engine and the image checker. The sheet ejector ejects, through the first ejection path, media sheets with images determined to be non-defective together with insertion sheets put between the media sheets, and further ejects media sheets with images determined to be defective through the second ejection path which is different from the first ejection path. The one or more controllers perform the following operations. That is, when the image checker receives a media sheet output from the print engine, the one or more controllers perform, by using the measured image obtained by the sensor, a check whether an image formed on the media sheet is defective or not. The one or more controllers then cause the sheet inserter to start putting an insertion sheet into the sheet path, after a determination that an image of one of media sheets output from the print engine (for example, a media sheet to be followed by the insertion sheet in the sheet path) is non-defective is made, as a result of the check.

In another case that unordered insertion sheets (insertion sheets that can be put between media sheets output from the print engine, regardless of order of the insertion sheets) are used for a process to create one or more print products according to a job, the sheet-ejection operations such that the sheet ejector ejects a printed media sheet on which a defective image has been detected and an insertion sheet following the media sheet to the same ejection tray, do not make a large problem. In other words, even if the image forming apparatus performs recovery printing in response to the detection of a defective image on a printed media sheet, the above-described operations do not cause disorder of pages of a resulting print product because all the insertion sheets are unordered insertion sheets that can be used regardless of the order. However, the image forming apparatus is configured to cause the sheet inserter to start putting an insertion sheet into the sheet path after the determination of an image formed on one of printed media sheets. It may cause a fall of the productivity of the image forming apparatus.

In view of that, in one embodiment of the present invention, the image forming apparatus is configured to define the timing of putting insertion sheets into the sheet path in accordance with a result of an estimation whether insertion sheets in the sheet inserter are unordered insertion sheets (insertion sheets that can be put between media sheets output from the print engine, regardless of order of the insertion sheets) or ordered insertion sheets (insertion sheets to be put between media sheets output from the print engine, in predetermined order). In concrete terms, the sensor of the image checker is configured to, in response to the image checker receiving an insertion sheet put into the sheet path, read a face of the insertion sheet and obtain measured image, and the one or more controllers are configured to perform an insertion-sheet check by using the measured images of a pair of insertion sheets put into the sheet path. In the insertion-sheet check, the one or more controllers estimate whether the pair of insertion sheets are unordered insertion sheets or ordered insertion sheets, and according to a result of the estimation, further estimate whether insertion sheets in the sheet inserter are unordered insertion sheets or ordered insertion sheets. The one or more controllers then define the timing of putting insertion sheets into the sheet path in accordance with a result of the estimation whether insertion sheets in the sheet inserter are unordered insertion sheets or ordered insertion sheets.

As described above, the image forming apparatus is configured to cause the sheet inserter to start putting an insertion sheet into the sheet path, after a completion of a determination that an image of one of media sheets output from the print engine is non-defective. It reduces wasteful use of insertion sheets and maintains the correct page order of print products. Further, with the apparatus's operations to define the timing of putting insertion sheets into the sheet path according to a result of an estimation whether insertion sheets in the sheet inserter are unordered insertion sheets or ordered insertion sheets, a fall of the productivity of the image forming apparatus can be minimized even if spoilage of sheets occurs in a process to make print products.

### Embodiment

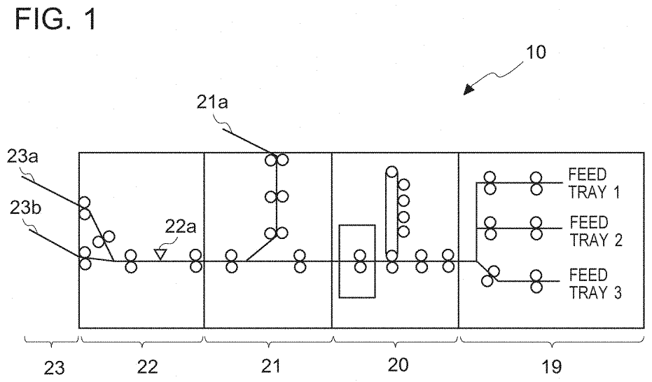

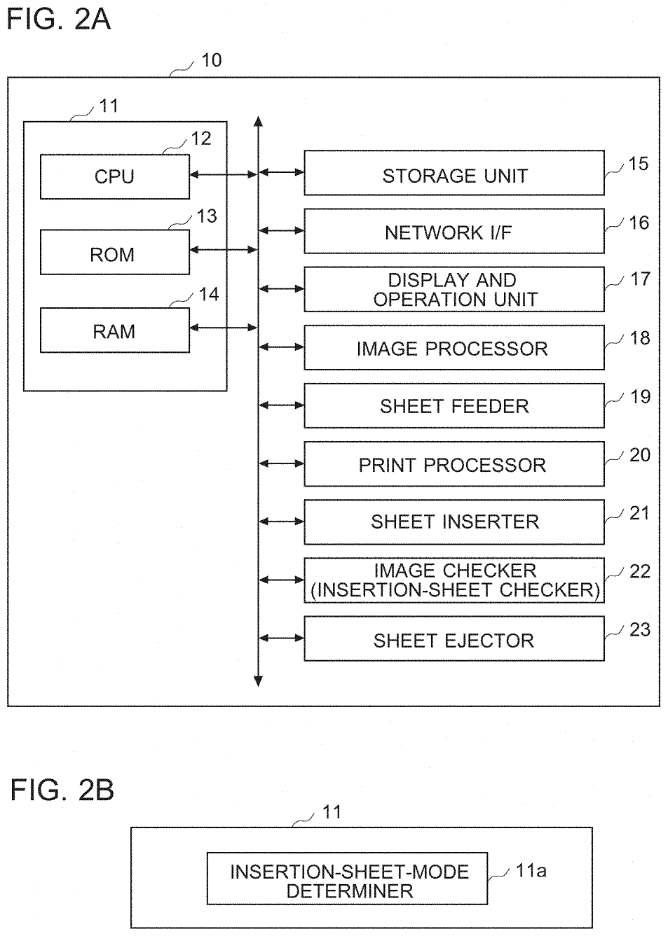

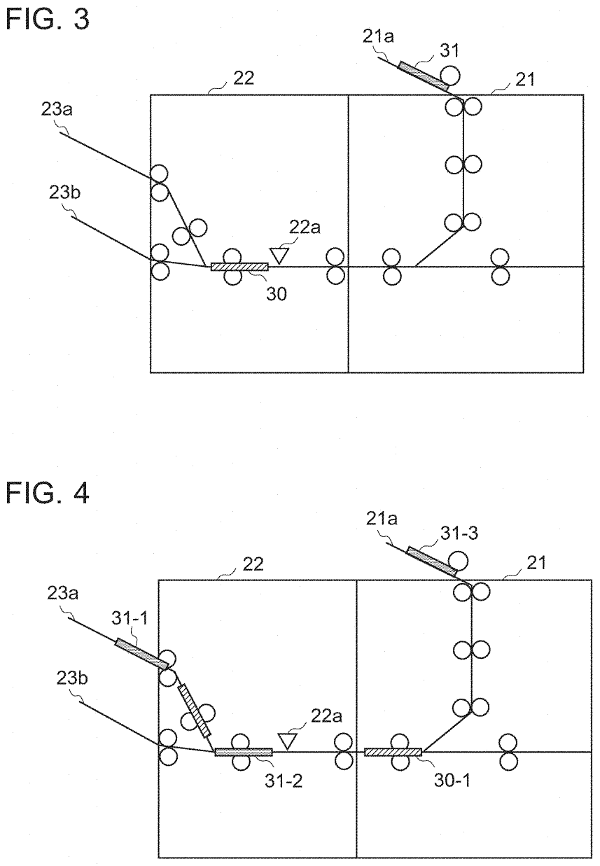

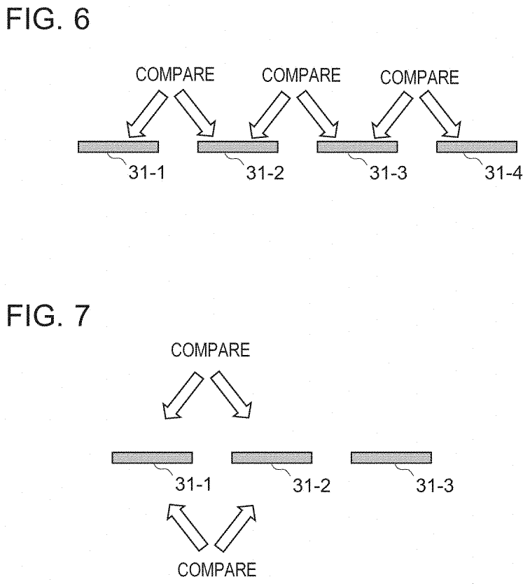

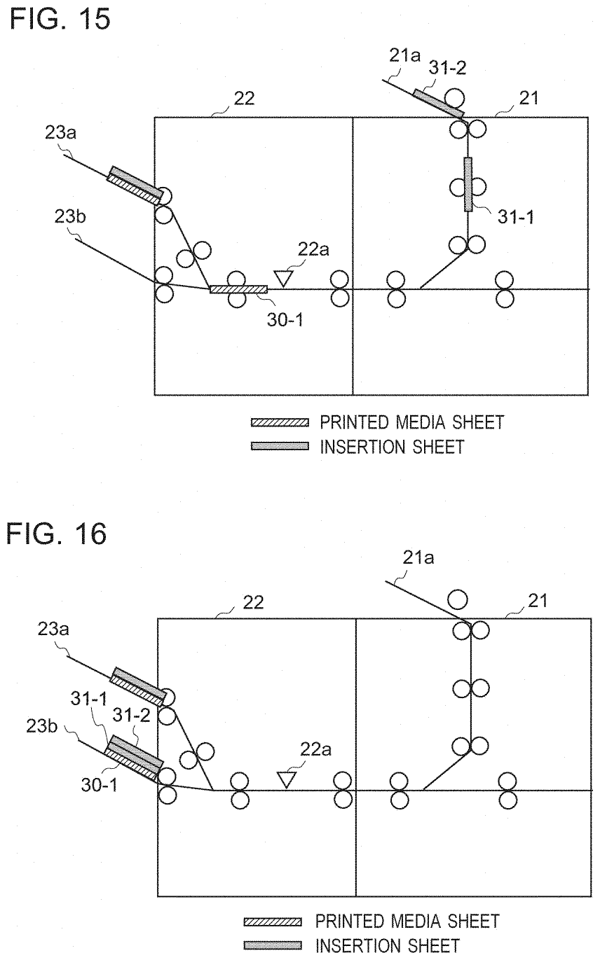

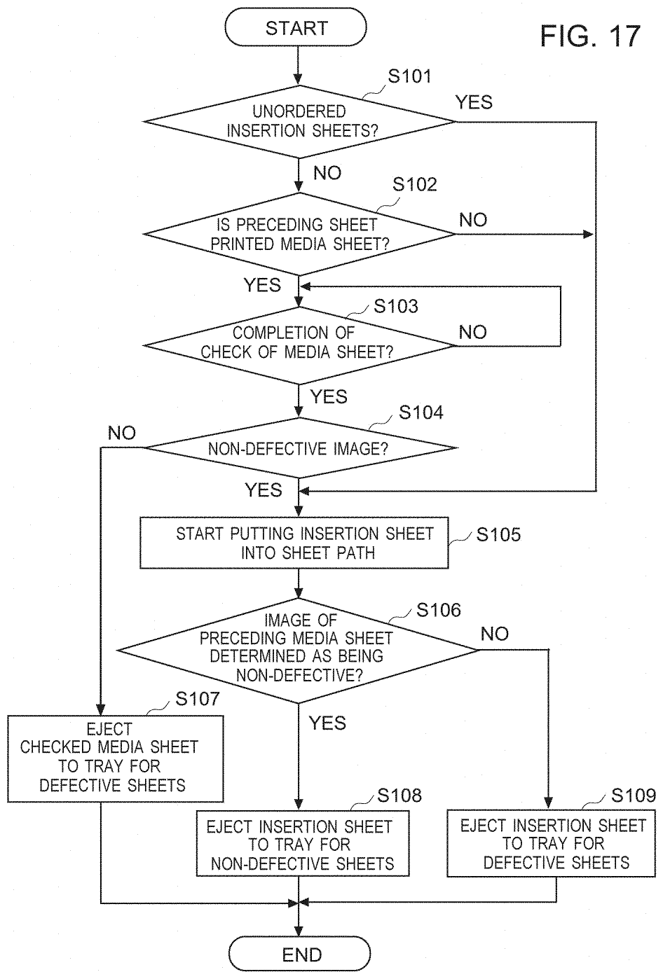

In order to describe an embodiment of the present invention in more in detail, a description is given of an image forming apparatus, a method of controlling sheet insertion, and a non-transitory computer-readable recording medium storing a program for controlling sheet insertion, with reference to FIG. 1 through FIG. 17. FIG. 1 is a schematic diagram illustrating an example of the constitution of an image forming apparatus according to the present embodiment. FIGS. 2A and 2B are block diagrams illustrating an example of the constitution of the image forming apparatus. FIGS. 3 to 5 each is a schematic diagram illustrating an example of timing of feeding an insertion sheet in the image forming apparatus. FIGS. 6 to 13 each is a schematic diagram illustrating an example of an insertion-sheet check in the operations of the image forming apparatus. FIG. 14 is a diagram illustrating an example of operation modes of the image forming apparatus. FIGS. 15 and 16 each is a schematic diagram illustrating an example of sheet ejection in the image forming apparatus. FIG. 17 is a flowchart illustrating an example of operations of the image forming apparatus.

### Image Forming Apparatus

Image forming apparatus 10 according to the present embodiment is an apparatus for processing print jobs and forming images on media sheets to create one or more print products, like a MFP. As illustrated in FIG. 1 and FIG. 2A, image forming apparatus 10 includes built-in controller 11, storage unit 15, network interface (I/F) 16, display and operation unit 17, image processor 18, sheet feeder 19, print processor 20, sheet inserter 21, image checker 22 and sheet ejector 23.

Built-in controller 11 includes CPU (Central Processing Unit) 11a, which is a hardware processor, and memories including ROM (Read Only Memory) 13 and RAM (Random Access Memory) 14. CPU 12 is configured to read out control programs (including a program for controlling sheet insertion which will be described later) stored in ROM 13 or storage unit 15, load the control programs onto RAM 14, and execute the control programs, thereby controlling operations of image forming apparatus 10.

Storage unit 15 is a non-transitory computer-readable recording medium including a HDD (hard disk drive) and/or a SSD (solid-state drive). Storage unit 15 stores programs which, when being executed, causes CPU 12 to control the components of image forming apparatus 10, information about processing and functions of image forming apparatus 10, a print job, image data created by image processor 18 and other data.

Network interface (I/F) 16 includes a NIC (Network Interface Card) and/or a modem, and communicably connects image forming apparatus 10 to a communication network so that image forming apparatus 10 can receive print jobs from a client terminal.

Display and operation unit 17 is a device configured to display various kinds of screens (like a screen for setting a sheet-insertion mode, which will be described later) and allow an operator to perform in the screens various kinds of operations (like an operation to choose the sheet-insertion mode in the screen). Examples of display and operation unit 17 include a touch screen in which an operation unit that works as an input device (a resistive touch sensor composed of lattice-shaped transparent electrodes or a capacitive touch sensor) is arranged on a display unit like a LCD (liquid-crystal display) or an OEL (organic electroluminescence) display. In the present embodiment, a touch screen, in which a display unit and an operation unit are housed in one body, is employed as an instance of display and operation unit 17, but alternatively, a display unit and an operation unit as separated bodies may be employed as an instance of display and operation unit 17.

Image processor 18 serves as a RIP (raster-image processor), and is configured to translate a print job into intermediate data (an intermediate format called the display list or DL), and then rasterize pages of a document provided by the print job to create bitmap image data. Image processor 18 is further configured to perform image processing, such as screening, tone correction, density-balance adjustment, thinning, halftoning and other processing, on image data as needed; and output the resulting image data to print processor 20.

Sheet feeder 19 includes one or more feed trays (in FIG. 1, feed trays 1 to 3) so as to feed media sheets (print sheets) loaded in a feed tray to print processor 20 through a sheet path.

Print processor 20 is a print engine that is configured to use image data on which image processing was performed by image processor 18, to form images on respective media sheets. Print processor 20 includes components necessary for forming images on respective media sheets by using electrographic processes or electrostatic recording process, in other words, includes, for example, a charging unit, a photoreceptor drum, an exposure unit, a developing unit, transfer rollers, a transfer belt and a fixing unit. In concrete terms, print processor 20 is configured to perform print processing as follows. The charging unit charges the photoreceptor drum, and the exposure unit irradiates the photoreceptor drum with light in accordance with image data, to create a latent image. The developing unit adheres charged toner onto the photoreceptor drum, to develop the toner image. The toner image is transferred onto a media sheet by using the transfer rollers (for the first transfer process) and the transfer belt (for the second transfer process). The fixing unit then fixes the toner image onto a media sheet.

Sheet inserter 21 includes one or more insertion trays for loading insertion sheets thereon (in FIG. 1, insertion tray 21a) and optionally includes a controller (hardware processor) for controlling a process to insert the insertion sheets from an insertion tray into the sheet path, where the insertion sheets are media sheets not to be subjected to print processing, like media sheets that had been printed by an external printing device in advance, interleaving sheets or blank sheets. Sheet inserter 21 is disposed so as to insert the insertion sheets loaded on an insertion tray into the sheet path (in the present embodiment, to put the insertion sheets to a position between print processor 20 and image checker 22 in the sheet path). Sheet inserter 21 is configured to start putting an insertion sheet from an insertion tray into the sheet path, after image checker 22 made a determination that an image of one of media sheets output from print processor 20 (a media sheet to be followed by the insertion sheet in the sheet path) is non-defective. Sheet inserter 21 is further configured to refer to a result of an estimation whether insertion sheets in sheet inserter 21 are unordered insertion sheets or ordered insertion sheets (an insertion-sheet check which will be described later), made by image checker 22 (or an insertion-sheet determiner), and start putting insertion sheets into the sheet path in accordance with the result. That is, on finding that insertion sheets in sheet inserter 21 are estimated to be ordered insertion sheets, sheet inserter 21 starts putting one of the insertion sheets into the sheet path after a completion of a check of an image formed on a media sheet downstream of the insertion sheet (a media sheet to be followed by the insertion sheet in the sheet path). On finding that insertion sheets in sheet inserter 21 are estimated to be unordered insertion sheets, sheet inserter 21 starts putting one of the insertion sheets into the sheet path without waiting for a completion of the check of an image formed on a media sheet downstream of the insertion sheet (a media sheet to be followed by the insertion sheet in the sheet path). In a case that an insertion sheet is going to be put into the sheet path, following a preceding insertion sheet having been put into the sheet path, sheet inserter 21 is further configured to start putting the insertion sheet into the sheet path, regardless of a result of the estimation whether the insertion sheets in sheet inserter 21 are unordered insertion sheets or ordered insertion sheets, without waiting for a completion of the check of an image formed on a media sheet followed by the preceding insertion sheet.

Image checker 22 includes a sensor capable of, in response to image checker 22 receiving a media sheet output from print processor 20, reading one face of a sheet or both faces of a sheet and obtaining measured image or images, at image-check position 22a in FIG. 1. Image checker 22 optionally includes a controller (a hardware processor) for checking the measured image or images obtained by the sensor. Image checker 22 is configured to, on receiving a printed media sheet, read an image formed on the media sheet with the sensor and perform a check whether the image formed on the media sheet is defective or not, by using the measured image obtained by the sensor. Examples of the sensor include an inline sensor at the position between print processor 20 and sheet ejector 23 in the sheet path. The inline sensor includes a CCD (charge-coupled device) array or a CMOS (complementary metal-oxide-semiconductor) that optically scans a face of a sheet. When image checker 22 receives a sheet, a light source emits light onto a face of the sheet to be scanned, the light reflected from the face is collected onto a photodetector (optical receiver) of the sensor, through a light-receiving lens. The sensor then converts the received light into electric signal according to the quantity of the received reflection light, and outputs signals as measurement data of the image of the face of the sheet.

Image checker 22 is further configured work as an insertion-sheet checker by using measured images of insertion sheets in the sheet path, obtained by the inline sensor. In concrete terms, in response to image checker 22 receiving an insertion sheet put into the sheet path, the inline sensor reads a face of the insertion sheet and obtains a measured image. Using the measured images of a pair of insertion sheets put into the sheet path, image checker 22 performs an insertion-sheet check. In the insertion-sheet check, image checker 22 estimates whether the pair of insertion sheets are unordered insertion sheets (insertion sheets that can be put between media sheets, regardless of order of the insertion sheets) or ordered insertion sheets (insertion sheets to be put between media sheets in predetermined order), and according to a result of the estimation, further estimate whether insertion sheets in sheet inserter 21 are unordered insertion sheets or ordered insertion sheets. Image checker 22 may perform the insertion-sheet check each time when image checker 22 (the inline sensor) receives an insertion sheet put into the sheet path by sheet inserter 21. As an example of such insertion-sheet check, the inline sensor may be configured to read both faces of an insertion sheet and obtain measured images, and image checker 22 may perform, in response to receiving an insertion sheet put into the sheet path, an estimation whether a pair of insertion sheets in the sheet path are unordered insertion sheets or ordered insertion sheets based on the measured images of first faces of the pair of insertion sheets and another estimation based on the measured images of second faces of the pair of insertion sheets. On finding that one or both of the estimations resulted in that the pair of insertion sheets are ordered insertion sheets, image checker 22 may estimate that the pair of insertion sheets are ordered insertion sheets as a result of the first estimation in the insertion-sheet check. As another example of the insertion-sheet check, after the first estimation in the insertion-sheet check (estimating whether a pair of insertion sheets in the sheet path are unordered insertion sheets or ordered insertion sheets) came to the same result for a predetermined number of times in succession, image checker 22 may omit the first estimation for the remaining insertion sheets till the end of processing of a current print job. As another example of the insertion-sheet check, after the first estimation in the insertion-sheet check came to the same result for a predetermined number of times in succession during creation of one of print products according to a print job, image checker 22 may omit the first estimation for the remaining insertion sheets during creation of remaining print products according the print job. As another example of the insertion-sheet check, on finding that the first estimation in the insertion-sheet check resulted in that a pair of the insertion sheets in the sheet path are unordered insertion sheets for a predetermined number of times in succession, image checker 22 may estimate that insertion sheets in sheet inserter 21 are unordered insertion sheets as a result of the second estimation in the insertion-sheet check. Image checker 22 may perform the above-described estimations by using various estimation bases (in other words, may choose one of bases to be used for the estimations). For example, the first estimation in the insertion-sheet check may be performed on the basis of measured images of predetermined areas of a pair of insertion sheets in the sheet path, obtained by the inline sensor. For another example, the first estimation in the insertion-sheet check may be performed on the basis of one or both of surface profiles of a pair of insertion sheets in the sheet path and colors of a pair of insertion sheets in the sheet path.

Sheet ejector 23 includes multiple output trays (in FIG. 1, output trays 23a and 23b) and corresponding ejection paths, for ejecting media sheets checked by image checker 22 and insertion sheets fed by sheet inserter 21, and optionally includes a controller (a hardware processor) for controlling sheet ejection. Sheet ejector 23 is configured to eject media sheets with images determined to be non-defective with image checker 22, into an output tray through an ejection path (first ejection path), together with insertion sheets put between the media sheets. Sheet ejector 23 is further configured to eject media sheets with images determined to be defective with image checker 22, into another output tray through another ejection path (second ejection path). Sheet ejector 23 may be further configured to, on image checker 22 making a determination that an image of one of media sheets output from print processor 20 is defective, confirm the presence of one or more insertion sheets having been put into the sheet path following the media sheet with a defective image, and put the one or more insertion sheets confirmed, into the ejection path for media sheets with defective images (second ejection path), together with the determined media sheet with a defective image.

As illustrated in FIG. 2B, built-in controller 31 is configured to work as sheet-insertion-mode determiner 11a.

Sheet-insertion-mode determiner 11a is configured to prompt an operator to define timing of putting insertion sheets into the sheet path by sheet insertor 21, by using a display like display and operation unit 17. Sheet-insertion-mode determiner 11a may be configured to present multiple modes of putting insertion sheets into the sheet path (sheet-insertion modes) on a display, to prompt an operator to choose one of the sheet-insertion modes. Examples of the sheet-insertion modes include an automatic mode, a productive mode and a quality-first mode. In the automatic mode, sheet inserter 21 starts putting each insertion sheet into the sheet path in accordance with a result of the insertion-sheet check performed by the insertion-sheet checker. In the productive mode, sheet inserter 21 disregards a result of the insertion-sheet check with the insertion-sheet checker and starts putting each insertion sheet into the sheet path without waiting for a completion of the check of an image formed on a media sheet to be followed by the each insertion sheet. In the quality-first mode, sheet inserter 21 disregards a result of the insertion-sheet check performed by the insertion-sheet checker and starts putting each insertion sheet after a completion of the check of an image formed on a media sheet to be followed by the each insertion sheet.

It should be noted that FIG. 1 and FIGS. 2A and 2B each illustrates an example of image forming apparatus 10 according to the present embodiment for illustrative purpose only, and the constitution and operations of the apparatus may be modified appropriately, as far as the above-described operations can be executed in the apparatus.

For example, sheet inserter 21 in the above description is configured to control feeding of insertion sheets according to a result of the check performed by image checker 22 (or the insertion-sheet checker). Alternatively, built-in controller 11 may be configured to determine the timing of putting insertion sheets into the sheet path according to a result of the check performed by image checker 22 (or the insertion-sheet checker), and cause sheet inserter 21 to start putting insertion sheets into the sheet path. For another example, image checker 22 in the above description is configured to perform the check whether an image formed on a received media sheet is defective or not by using measured image obtained by the inline sensor, and is configured to work as the insertion-sheet checker so as to perform the insertion-sheet check (estimating whether a pair of insertion sheets in the sheet path are unordered insertion sheets or ordered insertion sheets, and estimating whether insertion sheets in sheet inserter 21 are unordered insertion sheets or ordered insertion sheets) by using measured images of a pair of insertion sheets in the sheet path, obtained by the inline sensor. Alternatively, built-in controller 11 may be configured to receive the measured image of a media sheet from the inline sensor and perform the check of an image formed on the media sheet, and may be configured to receive the measured images of a pair of insertion sheets in the sheet path from the inline sensor and work as the insertion-sheet checker so as to perform the insertion-sheet check. For another example, sheet ejector 23 in the above description is configured to control sheet ejection. Alternatively, built-in controller 11 may be configured to eject media sheets with non-defective images, into the first ejection path, together with insertion sheets put between the media sheets, and to eject media sheets with defective images into the second ejection path. Built-in controller 11 may also be configured to, on image checker 22 making a determination that an image of one of media sheets output from print processor 20 is defective, confirm the presence of one or more insertion sheets having been put into the sheet path following the media sheet with a defective image, and put the one or more insertion sheets confirmed, into the second ejection path together with the media sheet with the defective. In other words, control sheet inserter 21, image checker 22 and sheet ejector 23 may include respective controllers configured to perform the above-described operations, or alternatively, built-in controller 11 may be configured to control sheet inserter 21, image checker 22 and sheet ejector 23, so as to perform the operations relating to the control of sheet conveyance in image forming apparatus 10, when built-in controller 11 (CPU 12) executes the program for controlling sheet insertion.

### Sheet Conveyance Control

Hereinafter, a description is given of operations to control sheet conveyance in image forming apparatus 10 according to the present embodiment in details, with reference to FIGS. 3 to 16. In these figures, rectangles hatched with lines indicate media sheets printed by print processor 20 and rectangles hatched with dots indicate insertion sheets. In each of FIGS. 3 to 5 and FIGS. 15 and 16, media sheets and insertion sheets are assumed to be conveyed in the sheet path from the right to the left of the figure.

A description is given of operations to start putting an insertion sheet into the sheet path, after a completion of a determination whether an image formed on one of printed media sheets is defective or not. As illustrated in FIG. 3, when media sheet 30 is output from print processor 20 and arrives at image-check position 22a in the sheet path, image checker 22 reads an image formed on the media sheet 30 with the inline sensor and image checker 22 (or built-in controller 11) checks whether the image formed on the media sheet 30 is defective or not. For example, by using the measured image of media sheet 30, image checker 22 (or built-in controller 11) checks whether the position of the image in a face of the sheet, the density of the image and/or the color of the image is appropriate or not, checks the presence of some dirt on the image and/or checks the presence of a folded or broken corner of the sheet. After the media sheet 30 has passed through the image-check position 22a in the sheet path toward output tray 23a or 23b and a determination that the image formed on the media sheet 30 is non-defective has been made, sheet inserter 21 starts putting insertion sheet 31 from insertion tray 21a into the sheet path (or built-in controller 11 causes sheet inserter 21 to start putting insertion sheet 31 from insertion tray 21a into the sheet path). As described-above, image forming apparatus 10 is configured to cause sheet inserter 21 to start putting an insertion sheet into the sheet path, after a completion of the check subjected to a media sheet to be followed by the insertion sheet in the sheet path. It reduces a wasteful use of insertion sheets in a process to make print products in total and maintains the page order of print products properly.

Next, a description is given of operations to control the timing of putting insertion sheets into the sheet path in accordance with a result of the insertion-sheet check. As illustrated in FIG. 4, image checker 22 (or built-in controller 11) uses measured images of insertion sheets 31-1 and 31-2 that passed through image-check position 22a in the sheet path and estimates whether the insertion sheets are unordered insertion sheets (insertion sheets that can be put between media sheets regardless of order of the insertion sheets) or ordered insertion sheets (insertion sheets to be put between media sheets in predetermined order). When estimating that the insertion sheets are ordered insertion sheets, image checker 22 (or built-in controller 11) estimates that insertion sheets in insertion tray 21a are ordered insertion sheets, and sheet inserter 21 starts putting insertion sheet 31-3 into the sheet path after a completion of the check of the image formed on media sheet 30-1 to be followed by insertion sheet 31-3 in the sheet path (the media sheet downstream of insertion sheet 31-3). In other words, sheet inserter 21 suspends putting insertion sheet 31-3 into the sheet path till a determination that an image formed on media sheet 30-1 downstream of insertion sheet 31-3 is non-defective is made, as a result of the check.

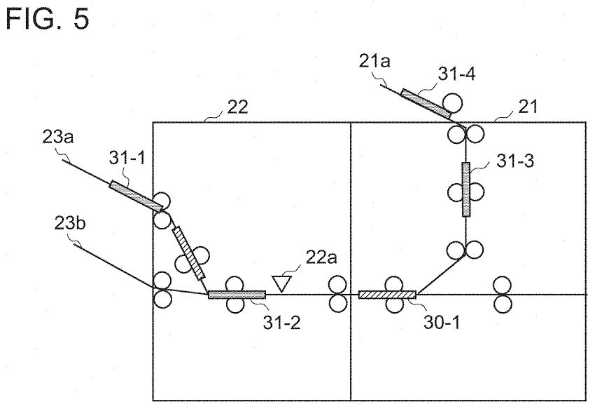

When estimating that insertion sheets 31-1 and 31-2 that passed through image-check position 22a in the sheet path are unordered insertion sheets, image checker 22 (or built-in controller 11) estimates that insertion sheets in insertion tray 21a (in FIG. 5, insertion sheets 31-3 and 31-4) are unordered insertion sheets, and sheet inserter 21 starts putting insertion sheet 31-3 into the sheet path without waiting for a completion of the check of the image formed on media sheet 30-1 to be followed by insertion sheet 31-3 in the sheet path (the media sheet downstream of insertion sheet 31-3), as illustrated in FIG. 5. As described above, image forming apparatus 10 is configured to define the timing of putting insertion sheets into the sheet path by sheet inserter 21 in accordance with a result of the estimation whether insertion sheets in sheet inserter 21 are unordered insertion sheets or ordered insertion sheets. It minimizes a fall of the productivity of image forming apparatus 10 even if spoilage of sheets occurs in operations of the apparatus.

Next, a description is given of the insertion-sheet check (estimation of the kinds of insertion sheets), with reference to FIGS. 6 to 10B. Each of the figures shows only insertion sheets in order of conveyance in the sheet path from the left to the right, for purpose of easy illustration, but in an actual sheet path, there are printed media sheets between the insertion sheets.

In an example of FIG. 6, when a comparison of measured images of insertion sheets 31-1 and 31-2 results in the estimation that the compared insertion sheets are unordered insertion sheets, image checker 22 (or built-in controller 11) estimates that insertion sheet 31-3 is also a unordered insertion sheet, and sheet inserter 21 starts putting the insertion sheet 31-3 into the sheet path without waiting for a completion of a check of an image formed on a media sheet to be followed by the insertion sheet 31-3 in the sheet path. When a comparison of measured images of insertion sheets 31-2 and 31-3 results in the estimation that the compared insertion sheets are ordered insertion sheets, image checker 22 (or built-in controller 11) estimates that insertion sheet 31-4 is an ordered insertion sheet, and sheet inserter 21 starts putting the insertion sheet 31-4 into the sheet path after a determination that an image formed on the media sheet to be followed by the insertion sheet 31-4 in the sheet path is non-defective is made. After that, each time when receiving an insertion sheet, image checker 22 (or built-in controller 11) compares measured images of a pair of insertion sheets in the sheet path (for examples, compares measured images of the insertion sheet received and the precedence insertion sheet in the sheet path) to estimate whether the compared insertion sheets are unordered insertion sheets or ordered insertion sheets, and then estimates the kind of an insertion sheet or sheets in sheet inserter 21.

In another example that image checker 22 is configured to read both faces of each insertion sheet 31 (for example, by using inline sensors disposed at both sides of the sheet path), image checker 22 (or built-in controller 11) compares measured images of one face (for example, the bottom face) of insertion sheet 31-1 and one face at the same side (the bottom face) of insertion sheet 31-2 obtained by the inline sensor and further compares measured images of the other face (the upper face) of insertion sheet 31-1 and the other face (the upper face) of insertion sheet 31-2 obtained by the inline sensor, as illustrated in FIG. 7. When the both comparisons result in the estimation that the compared insertion sheets are unordered insertion sheets, image checker 22 (or built-in controller 11) estimates that insertion sheet 31-3 is also a unordered insertion sheet, and sheet inserter 21 starts putting the insertion sheet 31-3 into the sheet path without waiting for a completion of the check of an image formed on the media sheet to be followed by the insertion sheet 31-3 in the sheet path. On the other hand, when one or both of the comparisons result in the estimation that the compared insertion sheets are ordered insertion sheets, image checker 22 (or built-in controller 11) estimates that insertion sheet 31-3 is also an ordered insertion sheet, and sheet inserter 21 starts putting the insertion sheet 31-3 into the sheet path after a completion of the check of an image formed on the media sheet to be followed by the insertion sheet 31-3 in the sheet path.

Image forming apparatus 10 can surely reduce wasteful use of insertion sheets by performing the above-described operations to compare measured images of insertion sheets in the sheet path to perform the estimation of the kinds of insertion sheets (insertion-sheet check) each time when image checker 22 receives an insertion sheet as illustrated in FIG. 6, or the above-described operations to perform a comparison of the measured images of first faces of insertion sheets in the sheet path and a comparison of the measured images of second faces of the insertion sheets to perform the estimation of the kinds of insertion sheets (insertion-sheet check) as illustrated in FIG. 7. Under the condition that image checker 22 can estimate whether an insertion sheet to be put in to the sheet path is an ordered insertion sheet or an unordered insertion sheet (in other words, whether insertion sheets in sheet inserter 21 are ordered insertion sheets or unordered insertion sheets), image checker 22 (or built-in controller 11) may omit the estimation of the kinds of insertion sheets.

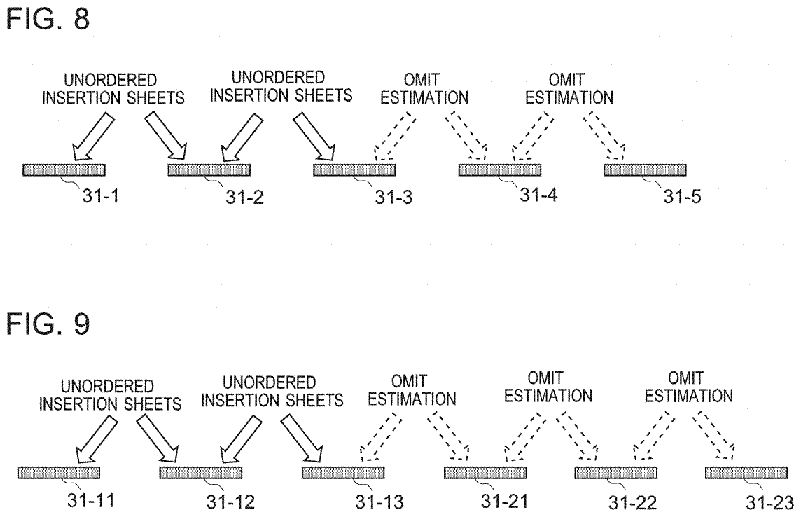

In an example of FIG. 8, a comparison of measured images of insertion sheets 31-1 and 31-2 results in the estimation that the compared insertion sheets are unordered insertion sheets (first estimation), and a comparison of measured images of insertion sheets 31-2 and 31-3 results in the estimation that the compared insertion sheets are unordered insertion sheets (second estimation). When the estimation of the kind of insertion sheets came to the same result for a predetermined number of times (in this case, the estimation came to the same result that the compared insertion sheets are unordered insertion sheets, for two times or two pairs of insertion sheets) in succession, it is highly probable that the comparison of measured images of insertion sheets 31-3 and 31-4 and the comparison of measured images of insertion sheets 31-4 and 31-5 also come to the same estimation result that the compared insertion sheets are unordered insertion sheets. Therefore image checker 22 (or built-in controller 11) may omit the estimation for these insertion sheets. In other words, image checker 22 (or built-in controller 11) may omit the estimation for the remaining insertion sheets till the end of processing of the current print job or before the start of processing the next print job.

In another example of FIG. 9 that image forming apparatus 10 processes a print job instructing to make copies of a print product, a comparison of measured images of insertion sheets 31-11 and 31-12 of a certain copy of the print product results in the estimation that the compared insertion sheets are unordered insertion sheets, and a comparison of measured images of insertion sheets 31-12 and 31-13 of the certain copy of the print product results in the estimation that the compared insertion sheets are unordered insertion sheets. When the estimation of the kind of insertion sheets came to the same result for a predetermined number of times (in this case, the estimation came to the same result that the compared insertion sheets are unordered insertion sheets, for multiple times or pairs of insertion sheets) in succession during creation of a certain copy of the print product according to the print job, it is highly probable that the comparison of measured images of insertion sheet 31-13 of the certain copy of the print product and insertion sheet 31-21 of the next copy of the print product, the comparison of measured images of insertion sheets 31-21 and 31-22 of the next copy of the print product, and the comparison of measured images of insertion sheets 31-22 and 31-23 of the next copy of the print product also come to the same estimation result that the compared insertion sheets are unordered insertion sheets. Therefore, image checker 22 (or built-in controller 11) may omit the estimation for these insertion sheets. In other words, image checker 22 (or built-in controller 11) may omit the estimation during creation of the remaining print products according the print job.

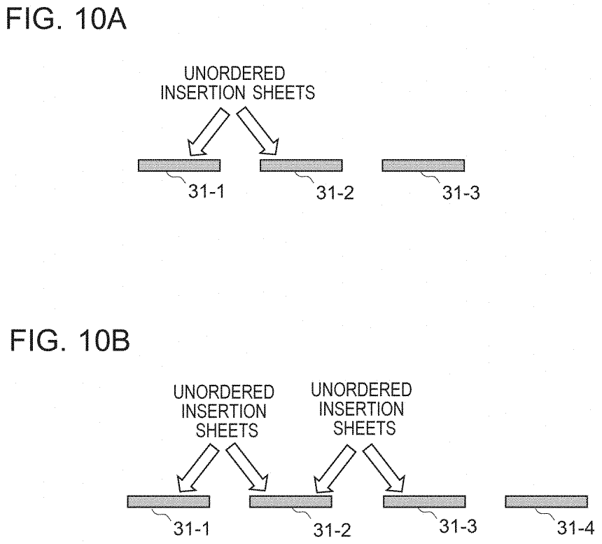

In another example, when a comparison of measured images of insertion sheets 31-1 and 31-2 results in the estimation that the compared insertion sheets are unordered insertion sheets, as illustrated in FIG. 10A, image checker 22 (or built-in controller 11) does not estimate insertion sheet 31-3 to be an unordered insertion sheet at this time because only one comparison has been made. That is, image checker 22 (or built-in controller 11) temporarily estimates that insertion sheet 31-3 is an ordered insertion sheet at this time. Next, when a comparison of measured images of insertion sheets 31-2 and 31-3 results in the estimation that the compared insertion sheets are unordered insertion sheets, as illustrated in FIG. 10B, image checker 22 (or built-in controller 11) estimates insertion sheet 31-4 to be an unordered insertion sheet because the estimation came to the same result that the compared insertion sheets are unordered insertion sheets for a predetermined number of times (in this case, two times) in succession. As described above, image forming apparatus 10 is configured not to estimate insertion sheets in sheet inserter to be unordered insertion sheets at the time when only one estimation of insertion sheets in the sheet path has been made, and to estimate insertion sheets in sheet inserter to be unordered insertion sheets when finding that the estimation of insertion sheets in the sheet path came to the same result that the compared insertion sheets are unordered insertion sheets for a predetermined number of times in succession. It reduces wasteful use of the insertion sheets and minimizes a fall of the productivity of the image forming apparatus even if spoilage of sheets occurs in print processing of image forming apparatus 10.

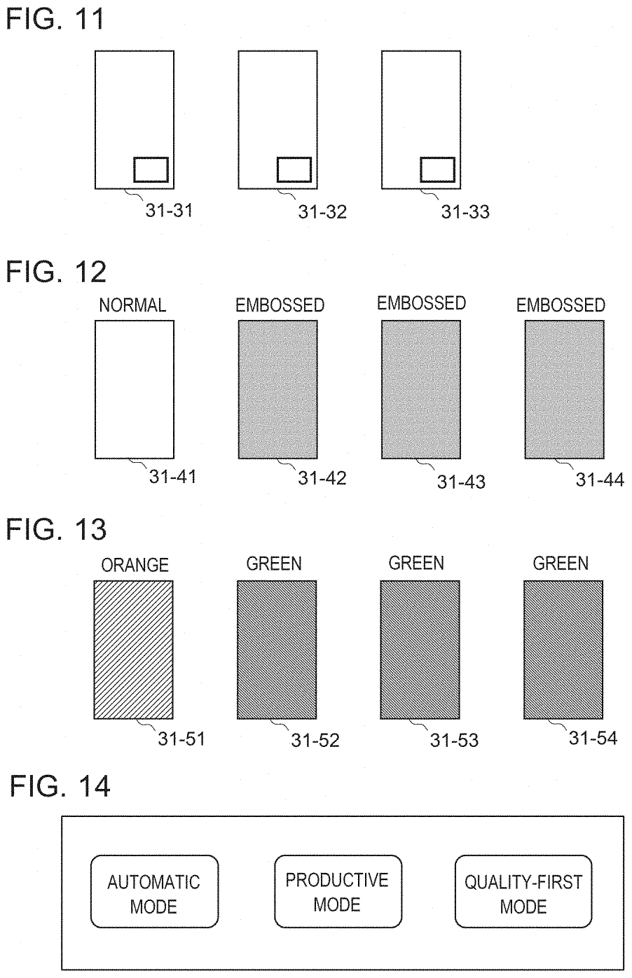

Image checker 22 (or built-in controller 11) may use various bases for the estimation of the kind insertion sheets. For example, image checker 22 (or built-in controller 11) may perform the estimation on the basis of the whole part of the insertion sheets, or the same and predetermined areas of the insertion sheets. As illustrated in FIG. 11, image checker 22 (or built-in controller 11) may perform the estimation on the basis of measured images within the areas enclosed in rectangles with thick lines on faces of insertion sheets 31-31 and 31-32. Comparing measured images within the areas (for example, predetermined areas where a page number is to be printed) of insertion sheets 31-31 and 31-32, and then estimating that insertion sheets 31-31 and 31-32 are unordered insertion sheets, image checker 22 (or built-in controller 11) may estimate insertion sheet 31-33 to be also a unordered insertion sheet, even if measured images outside of the predetermined areas of the insertion sheets 31-31, 31-32 and 31-33 are different from each other.

For another example, image checker 22 (or built-in controller 11) may perform the estimation on the basis of surface profiles of insertion sheets. In the example of FIG. 12, insertion sheet 31-41 of normal paper and insertion sheets 31-42 to 31-44 of embossed paper are conveyed in the sheet path. In FIG. 12, these paper kinds are indicated by using different hatching patterns. Insertion sheets 31-41 and 31-42 in FIG. 12 are different in surface profile and the distribution of light reflected from a face of insertion sheet 31-41 is different from that of insertion sheet 31-42. Comparing measured images of insertion sheets 31-41 and 31-42, image checker 22 (or built-in controller 11) estimates that insertion sheets 31-41 and 31-42 are ordered insertion sheets, and then estimates that insertion sheet 31-43 is also an ordered insertion sheet. Further comparing measured images of insertion sheets 31-42 and 31-43, which are the same in surface profile, image checker 22 (or built-in controller 11) estimates that insertion sheets 31-42 and 31-43 are unordered insertion sheets, and then estimates that insertion sheet 31-44 is also an unordered insertion sheet.

For another example, image checker 22 (or built-in controller 11) may perform the estimation on the basis of colors of insertion sheets. In the example of FIG. 13, insertion sheet 31-51 of orange and insertion sheets 31-52 to 31-54 of green are conveyed in the sheet path. In FIG. 13, these paper colors are indicated by using different hatching patterns. Comparing measured images of insertion sheets 31-51 and 31-52, which are different in color, image checker 22 (or built-in controller 11) estimates that insertion sheets 31-51 and 31-52 are ordered insertion sheets, and then estimates that insertion sheet 31-53 is also an ordered insertion sheet. Further comparing measured images of insertion sheets 31-52 and 31-53, which are the same in color, image checker 22 (or built-in controller 11) estimates that insertion sheets 31-52 and 31-53 are unordered insertion sheets, and then estimates that insertion sheet 31-54 is also an unordered insertion sheet.

As described above, image checker 22 (or built-in controller 11) is configured to define the timing of putting insertion sheets 31 into the sheet path according to a result of the estimation whether insertion sheets in sheet inserter 21 are ordered insertion sheets or unordered insertion sheets. It reduces wasteful use of insertion sheets even if spoilage of printed media sheets occurs in print processing of image forming apparatus 10. However, some operators may hope to avoid a fall of the productivity of image forming apparatus 10 which comes from the operations to perform the estimation of the kind of insertion sheets before causing insertion sheet 31 to start putting an insertion sheet into the sheet path. In view of that, image forming apparatus 10 according to the present embodiment is configured to work in one of operation modes (sheet-insertion modes) by using sheet-insertion-mode determiner 11a (built-in controller 11) so as to prompt an operator to define timing of putting insertion sheets into the sheet path by sheet insertor 21. For example, as illustrated in FIG. 14, insertion-mode determiner 11a (or built-in controller 11) is configured to cause display and operation unit 17 to display multiple operation modes (in this case, three sheet-insertion modes of “automatic mode”, “productive-mode” and “quality-first mode”) in a screen for setting the sheet-insertion mode so as to prompt an operator to choose one of the modes in the screen.

Under the condition that the automatic mode is chosen, sheet inserter 21 (or built-in controller 11) refers to a result of the estimation whether insertion sheets in sheet inserter 21 are ordered insertion sheets or unordered insertion sheets, made by the insertion-sheet checker (or built-in controller 11), and starts putting each insertion sheet 31 into the sheet path in accordance with the estimation result, as described above. When finding that insertion sheets in sheet inserter 21 are estimated to be ordered insertion sheets, sheet inserter 21 starts putting each insertion sheet into the sheet path after a completion of the check of an image formed on the media sheet to be followed by the each insertion sheet (the media sheet downstream of the each insertion sheet). When finding that insertion sheets in sheet inserter 21 are estimated to be unordered insertion sheets, sheet inserter 21 starts putting each insertion sheet into the sheet path without waiting for a completion of the check of an image formed on the media sheet to be followed by the each insertion sheet (the media sheet downstream of the each insertion sheet).

Under the condition that the productive mode is chosen, sheet inserter 21 (or built-in controller 11) disregards a result of the estimation whether insertion sheets in sheet inserter 21 are ordered insertion sheets or unordered insertion sheets, made by the insertion-sheet checker (or built-in controller 11), and starts putting each insertion sheet 31 into the sheet path without waiting for a completion of the check of an image formed on the media sheet to be followed by the each insertion sheet (the media sheet downstream of the each insertion sheet).

Under the condition that the quality-first mode is chosen, sheet inserter 21 (or built-in controller 11) disregards a result of the estimation whether insertion sheets in sheet inserter 21 are ordered insertion sheets or unordered insertion sheets, made by the insertion-sheet checker (or built-in controller 11), and starts putting each insertion sheet 31 into the sheet path after a completion of the check of an image formed on the media sheet to be followed by the each insertion sheet (the media sheet downstream of the each insertion sheet).

Next, a description is given of operations to eject printed media sheets 30 and insertion sheets 31, with reference to FIGS. 15 and 16. When insertion sheet 31-1 is going to be put into the sheet path from insertion tray 21a, sheet inserter 21 (or built-in controller 11) checks a sheet to be followed by the insertion sheet 31-1 in the sheet path (in other words, a sheet downstream of insertion sheet 31-1). As illustrated in FIG. 15, media sheet 30-1 is to be followed by insertion sheet 31-1 in the sheet path (in other words, media sheet 30-1 is positioned downstream of insertion sheet 31-1), and sheet inserter 21 starts putting insertion sheet 31-1 after a determination that an image formed on media sheet 30-1 is non-defective has been made by image checker 22 (or built-in controller 11). When insertion sheet 31-2 is going to be put into the sheet path from insertion tray 21a, insertion sheet 31-1 is to be followed by insertion sheet 31-2 in the sheet path (in other words, insertion sheet 31-1 is positioned downstream of insertion sheet 31-2), and insertion sheet 31-1 is not subjected to the determination that an image formed on the sheet is defective or not, when passing through image checker 22. Therefore, sheet inserter 21 starts putting insertion sheet 31-2 without waiting for the time when insertion sheet 31-1 passes through image checker 22. Sheet ejector 23 puts media sheets with non-defective images and insertion sheets, into one of ejection paths to eject these sheets into ejection tray 23a.

When image checker 22 (or built-in controller 11) made a determination that an image formed on media sheet 30-1 is defective in the example of FIG. 15, sheet ejector 23 puts the media sheet 30-1 with defective image into another ejection path to eject the media sheet 31-1 into ejection tray 23b, rather than ejection tray 23a, as illustrated in FIG. 16. At the same time, sheet ejector 23 (or built-in controller 11) confirms the presence of one or more insertion sheets having been put into the sheet path following the media sheet 30-1, and sheet ejector 23 then puts the one or more insertion sheets confirmed (in this case, insertion sheets 31-1 and 31-2), into the same ejection path to eject the insertion sheets into ejection tray 23b together with media sheet 30-1 with a defective image.

### Operations of Image Forming Apparatus

Hereinafter, a description is given of operations of image forming apparatus 10 according to the present embodiment in details. CPU 32 reads out the program for controlling sheet insertion stored in ROM 33 or storage unit 35, loads the program onto RAM 34, and executes the program, thereby executing the steps of the flowchart illustrated in FIG. 17.

In response to receiving an insertion sheet put into the sheet path, image checker 22 or the insertion-sheet checker (or built-in controller 11) uses measured images of a pair of insertion sheets put into the sheet path and performs the insertion-sheet check (estimates whether the pair of insertion sheets are unordered insertion sheets or ordered insertion sheets, and further estimates whether insertion sheets in the sheet inserter are unordered insertion sheets or ordered insertion sheets in accordance with a result of the first estimating) (Step S101). Before putting an insertion sheet into the sheet path, image checker 22 (or built-in controller 11) checks whether the preceding sheet (the sheet positioned downstream of the insertion sheet to be fed into the sheet path) is a printed media sheet or not (Step S102). When insertion sheets in sheet inserter 21 are estimated to be unordered insertion sheets (YES in Step S101), or the preceding sheet is not determined to be a printed media sheet (is determined to be an insertion sheet) (NO in Step S102), the operations jump to Step S105 because there is no need to wait for a completion of the check of an image formed on the preceding sheet with image checker 22. When insertion sheets in sheet inserter 21 are estimated to be ordered insertion sheets (NO in Step S101) and the preceding sheet is determined to be a printed media sheet (YES in Step S102), sheet inserter 21 suspends putting the insertion sheet till the end of the check of the image formed on the media sheet with image checker 22 (or built-in controller 11) (Step S103).

When the check has been completed (YES in Step S103), sheet inserter 21 (or built-in controller 11) refers to the result of the check and confirms whether the check came to the result that the image formed on the preceding media sheet is non-defective (Step S104). When the image of the media sheet was determined to be defective (NO in Step S104), sheet inserter 21 suspends putting the insertion sheet into the sheet path and sheet ejector 23 puts the checked media sheet with defective image into the second ejection path to eject the sheet into the ejection tray for defective sheets (Step S107), and the operations end.

When the image of the media sheet was determined to be non-defective (YES in Step S104), sheet inserter 21 starts putting the insertion sheet into the sheet path (Step S105). Sheet ejector 23 (or built-in controller 11) then refers to the result of the check and confirms whether the check came to the result that the image formed on the preceding media sheet is non-defective. When finding that the check resulted in that the image is non-defective (YES in Step S106), sheet ejector 23 puts the insertion sheet that had been put into the first sheet path, into the ejection path to eject the insertion sheet into the ejection tray for non-defective sheets (Step S108). When finding that the check resulted in that the image is defective (NO in Step S106), sheet ejector 23 puts the insertion sheet that had been put into the sheet path, into the second ejection path to eject the insertion sheet into the ejection tray for defective sheets (Step S109), and the operations end.

As described above, image forming apparatus 10 is configured to cause sheet inserter 21 to start putting an insertion sheet into the sheet path, after a determination that an image of one of printed media sheets (the preceding media sheet). It reduces wasteful use of insertion sheets and maintains the correct page order of print products. Further, image forming apparatus 10 is configured to define the timing of putting insertion sheets into the sheet path by sheet inserter 21 in accordance with a result of the estimation whether insertion sheets in sheet inserter 21 are unordered insertion sheets or ordered insertion sheets. It minimizes a fall of the productivity of image forming apparatus 10 even if spoilage of sheets occurs in operations of the apparatus.

It should be noted that the present invention should not be limited to the above-described embodiments, and the constitution and operations of the image forming apparatus can be modified appropriately, unless the modification deviates from the intention of the present invention.

For example, the above-described embodiments gave image forming apparatus 10 includes print processor 20, sheet inserter 21, image checker 22 and sheet ejector 23. But alternatively, an image check apparatus including sheet inserter 21 and image checker 22 may be prepared separately from the image forming apparatus 10, so that the image check apparatus can receive printed media sheets and execute the above-described method of controlling sheet insertion in the same manner.

The present invention is applicable to image forming apparatuses equipped with a sheet inserter for inserting insertion sheets between media sheets, methods of controlling sheet insertion in the image forming apparatus, programs for controlling sheet insertion to be executed in the image forming apparatus, and non-transitory computer-readable recording media each storing the program for controlling sheet insertion.

Although embodiments of the present invention have been described and illustrated in detail, it is clearly understood that the same is by way of illustration and example only and not limitation, the scope of the present invention should be interpreted by terms of the appended claims.

1. An image forming apparatus that processes a job to create one or more print products, comprising:
a print engine that forms images on respective media sheets;
an image checker comprising a sensor that, in response to the image checker receiving a media sheet output from the print engine, reads an image formed on the media sheet to obtain a measured image for use in a check whether the image is defective or not;
a sheet inserter that puts insertion sheets into a sheet path between the print engine and the image checker;
a sheet ejector that ejects media sheets subjected to the check and insertion sheets put into the sheet path by the sheet inserter, the sheet ejector comprising a first ejection path for ejecting media sheets with images determined to be non-defective together with insertion sheets put between the media sheets, and a second ejection path, being different from the first ejection path, for ejecting media sheets with images determined to defective; and
one or more controllers that perform operations comprising:
on the image checker receiving a media sheet output from the print engine, performing, by using the measured image obtained by the sensor, a check whether an image formed on the media sheet is defective or not; and
causing the sheet inserter to start putting an insertion sheet into the sheet path, after a determination that an image of one of media sheets output from the print engine is non-defective is made, as a result of the check.

2. The image forming apparatus of claim 1,
wherein, the sensor reads, in response to the image checker receiving an insertion sheet put into the sheet path, a face of the insertion sheet and obtains a measured image, and
the operations further comprise performing an insertion-sheet check by using the measured images of a pair of insertion sheets put into the sheet path, comprising
first estimating whether the pair of insertion sheets are unordered insertion sheets or ordered insertion sheets, and
second estimating, according to a result of the first estimating, whether insertion sheets in the sheet inserter are unordered insertion sheets or ordered insertion sheets,
wherein the unordered insertion sheets are insertion sheets that can be put between media sheets output from the print engine, regardless of order of the insertion sheets, and the ordered insertion sheets are insertion sheets to be put between media sheets output from the print engine, in predetermined order.

3. The image forming apparatus of claim 2,
wherein the causing the sheet inserter, comprises
referring to a result of the insertion-sheet check, and
on finding that the insertion sheets in the sheet inserter are estimated to be ordered insertion sheets, causing the sheet inserter to start putting one of the insertion sheets into the sheet path after a completion of the check subjected to one of media sheets output from the print engine, the one of the media sheets being to be followed by the one of the insertion sheets in the sheet path.

4. The image forming apparatus of claim 2,
wherein the causing the sheet inserter, comprises
referring to a result of the insertion-sheet check, and
on finding that the insertion sheets in the sheet inserter are estimated to be unordered insertion sheets, causing the sheet inserter to start putting one of the insertion sheets into the sheet path without waiting for a completion of the check subjected to one of media sheets output from the print engine, the one of the media sheets being to be followed by the one of the insertion sheets in the sheet path.

5. The image forming apparatus of claim 2,
wherein the one or more controllers perform the insertion-sheet check each time when the image checker receives an insertion sheet put into the sheet path by the sheet inserter.

6. The image forming apparatus of claim 2,
wherein the sensor reads, in response to the image checker receiving an insertion sheet put into the sheet path, both faces of the insertion sheet and obtains measured images, and
the insertion-sheet check comprises
performing estimations whether the pair of insertion sheets are unordered insertion sheets or ordered insertion sheets based on the measured images of first faces of the pair of insertion sheets and on the measured images of second faces of the pair of insertion sheets, and
on finding that one or both of the estimations resulted in that the pair of insertion sheets are ordered insertion sheets, estimating that the pair of insertion sheets are ordered insertion sheets as a result of the first estimating.

7. The image forming apparatus of claim 2,
wherein the one or more controllers perform the insertion-sheet check each time when the image checker receives an insertion sheet put into the sheet path by the sheet inserter, and
after the first estimating came to a same result for a predetermined number of times in succession, the one or more controllers omit the first estimating till an end of processing of a current job.

8. The image forming apparatus of claim 2,
wherein the one or more controllers perform the insertion-sheet check each time when the image checker receives an insertion sheet put into the sheet path by the sheet inserter, and
after the first estimating came to a same result for a predetermined number of times in succession during creation of one of print products according to a job, the one or more controllers omit the first estimating during creation of remaining print products according the job.

9. The image forming apparatus of claim 2,
wherein the one or more controllers perform the insertion-sheet check each time when the image checker receives an insertion sheet put into the sheet path by the sheet inserter, and
the insertion-sheet check comprises,
on finding that the first estimating resulted in that the pair of the insertion sheets are unordered insertion sheets for a predetermined number of times in succession, estimating that the insertion sheets in the sheet inserter are unordered insertion sheets as a result of the second estimating.

10. The image forming apparatus of claim 2,
wherein the operations further comprise choosing one of bases to be used for the first estimating.

11. The image forming apparatus of claim 10,
wherein the insertion-sheet check comprises performing the first estimating on a basis of measured images of predetermined areas of the pair of insertion sheets obtained by the sensor.

12. The image forming apparatus of claim 10,
wherein the insertion-sheet check comprises performing the first estimating on a basis of one or both of surface profiles of the pair of insertion sheets and colors of the pair of insertion sheets.

13. The image forming apparatus of claim 2,
wherein the operations further comprise prompting an operator to define timing of putting insertion sheets into the sheet path by the sheet insertor.

14. The image forming apparatus of claim 13,
wherein the prompting comprises prompting an operator to choose a mode of putting insertion sheets into the sheet path from
an automatic mode in which the sheet inserter starts putting each insertion sheet into the sheet path in accordance with a result of the insertion-sheet check,
a productive mode in which the sheet inserter disregards a result of the insertion-sheet check and starts putting each insertion sheet into the sheet path without waiting for a completion of the check subjected to one of media sheets output from the print engine, the one of the media sheets being to be followed by the each insertion sheet, and
a quality-first mode in which the sheet inserter disregards a result of the insertion-sheet check and starts putting each insertion sheet after a completion of the check subjected to one of media sheets output from the print engine, the one of the media sheets being to be followed by the each insertion sheet.

15. The image forming apparatus of claim 2,
wherein the operations further comprise causing the sheet inserter to start putting an insertion sheet into the sheet path next to a preceding insertion sheet having been put into the sheet path, regardless of a result of the insertion-sheet check, without waiting for a completion of the check subjected to a media sheet followed by the preceding insertion sheet.

16. The image forming apparatus of claim 1,
wherein the operations further comprise,
on making a determination that an image of one of media sheets output from the print engine is defective, as a result of the check, confirming presence of one or more insertion sheets having been put into the sheet path following the one of media sheets, and
causing the sheet ejector to put the one or more insertion sheets confirmed, into the second ejection path together with the one of media sheets.

17. A method of controlling sheet insertion in an image forming apparatus that processes a job to create one or more print products, the image forming apparatus comprising:
a print engine that forms images on respective media sheets;
an image checker comprising a sensor that, in response to the image checker receiving a media sheet output from the print engine, reads an image formed on the media sheet to obtain a measured image for use in a check whether the image is defective or not;
a sheet inserter that puts insertion sheets into a sheet path between the print engine and the image checker;
a sheet ejector that ejects media sheets subjected to the check and insertion sheets put into the sheet path by the sheet inserter, the sheet ejector comprising a first ejection path for ejecting media sheets with images determined to be non-defective together with insertion sheets put between the media sheets, and a second ejection path, being different from the first ejection path, for ejecting media sheets with images determined to be defective; and
one or more controllers, the method comprising:
on the image checker receiving a media sheet output from the print engine, performing, by the one or more controllers, a check whether an image formed on the media sheet is defective or not, by using the measured image obtained by the sensor; and
causing the sheet inserter to start putting an insertion sheet into the sheet path, by the one or more controllers, after a determination that an image of one of media sheets output from the print engine is non-defective is made, as a result of the check.

18. The method of claim 17,
wherein the sensor reads, in response to the image checker receiving an insertion sheet put into the sheet path, a face of the insertion sheet and obtains a measured image, and
the method further comprises performing, by the one or more controllers, an insertion-sheet check by using the measured images of a pair of insertion sheets put into the sheet path, comprising
first estimating whether the pair of insertion sheets are unordered insertion sheets or ordered insertion sheets, and
second estimating, according to a result of the first estimating, whether insertion sheets in the sheet inserter are unordered insertion sheets or ordered insertion sheets,
wherein the unordered insertion sheets are insertion sheets that can be put between media sheets output from the print engine, regardless of order of the insertion sheets, and the ordered insertion sheets are insertion sheets to be put between media sheets output from the print engine, in predetermined order.

19. The method of claim 18,
wherein the causing the sheet inserter, comprises
referring to a result of the insertion-sheet check, and
on finding that the insertion sheets in the sheet inserter are estimated to be ordered insertion sheets, causing the sheet inserter to start putting one of the insertion sheets into the sheet path after a completion of the check subjected to one of media sheets output from the print engine, the one of the media sheets being to be followed by the one of the insertion sheets in the sheet path.

20. The method of claim 18,
wherein the causing the sheet inserter, comprises
referring to a result of the insertion-sheet check, and
on finding that the insertion sheets in the sheet inserter are estimated to be unordered insertion sheets, causing the sheet inserter to start putting one of the insertion sheets into the sheet path without waiting for a completion of the check subjected to one of media sheets output from the print engine, the one of the media sheets being to be followed by the one of the insertion sheets in the sheet path.

21. A non-transitory computer-readable recording medium storing a program for controlling sheet insertion in an image forming apparatus that processes a job to create one or more print products, the image forming apparatus comprising:
a print engine that forms images on respective media sheets;
an image checker comprising a sensor that, in response to the image checker receiving a media sheet output from the print engine, reads an image formed on the media sheet to obtain a measured image for use in a check whether the image is defective or not;
a sheet inserter that puts insertion sheets into a sheet path between the print engine and the image checker;
a sheet ejector that ejects media sheets subjected to the check and insertion sheets put into the sheet path by the sheet inserter, the sheet ejector comprising a first ejection path for ejecting media sheets with images determined to be non-defective together with insertion sheets put between the media sheets, and a second ejection path, being different from the first ejection path, for ejecting media sheets with images determiner to be defective; and
one or more controllers, the program comprising instructions which, when being executed by the one or more controllers, cause the one or more controllers to perform operations comprising:
on the image checker receiving a media sheet output from the print engine, performing, by using the measured image obtained by the sensor, a check whether an image formed on the media sheet is defective or not; and
causing the sheet inserter to start putting an insertion sheet into the sheet path, after a determination that an image of one of media sheets output from the print engine is non-defective is made, as a result of the check.

22. The non-transitory computer-readable recording medium of claim 21,
wherein the sensor reads, in response to the image checker receiving an insertion sheet put into the sheet path, a face of the insertion sheet and obtains a measured image, and
the operations further comprise performing an insertion-sheet check by using the measured images of a pair of insertion sheets put into the sheet path, comprising
first estimating whether the pair of insertion sheets are unordered insertion sheets or ordered insertion sheets, and
second estimating, according to a result of the first estimating, whether insertion sheets in the sheet inserter are unordered insertion sheets or ordered insertion sheets,
wherein the unordered insertion sheets are insertion sheets that can be put between media sheets output from the print engine, regardless of order of the insertion sheets, and the ordered insertion sheets are insertion sheets to be put between media sheets output from the print engine, in predetermined order.

23. The method of claim 22,
wherein the causing the sheet inserter, comprises
referring to a result of the insertion-sheet check, and
on finding that the insertion sheets in the sheet inserter are estimated to be ordered insertion sheets, causing the sheet inserter to start putting one of the insertion sheets into the sheet path after a completion of the check subjected to one of media sheets output from the print engine, the one of the media sheets being to be followed by the one of the insertion sheets in the sheet path.

24. The method of claim 22,
wherein the causing the sheet inserter, comprises
referring to a result of the insertion-sheet check, and
on finding that the insertion sheets in the sheet inserter are estimated to be unordered insertion sheets, causing the sheet inserter to start putting one of the insertion sheets into the sheet path without waiting for a completion of the check subjected to one of media sheets output from the print engine, the one of the media sheets being to be followed by the one of the insertion sheets in the sheet path.
